(19) United States
(12) Patent Application Publication
(10) Pub. No.: US 2008/0143899 A1
(43) Pub. Date: Jun. 19, 2008

(54) LIQUID CRYSTAL DISPLAY DEVICE

(75) Inventor: Tomoyuki MAEDA, Osaka (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Toshiba Matsushita Display Technology Co., Ltd, Tokyo (JP)

(21) Appl. No.: 11/950,780

(22) Filed: Dec. 5, 2007

(30) Foreign Application Priority Data
Dec. 13, 2006 (JP) 2006-336224
Nov. 12, 2007 (JP) 2007-303093

(51) Int. Cl. G02F 1/133

(52) U.S. Cl. 349/34

(57) ABSTRACT

In a liquid crystal display device having an OCB liquid crystal panel, the frame frequency is set at 0.5 to 10 Hz and a reverse transition prevention voltage is set at 1 V while the liquid crystal panel is in a standby state.

### FIELD OF THE INVENTION

The present invention relates to an OCB (optically compensated birefringence) liquid crystal display device.

### BACKGROUND OF THE INVENTION

Conventionally, TN liquid crystal display devices have been used most commonly. However, recently, to improve the visibility of moving images, OCB liquid crystal display devices which are characterized in high response speeds have come to be incorporated in liquid crystal TV receivers, liquid crystal monitors, etc. (refer to Japanese Patent Application Kokai No. 2004-185027, for example).

OCB liquid crystal display devices perform display utilizing birefringence and hence can perform black display only at a particular voltage. As shown in FIG. 3, the transmittance increases and gradation inversion occurs in a voltage range 2 which is higher than the above optimum black display voltage. Therefore, in OCB liquid crystal display devices, the black display voltage V is set at the optimum black display voltage Vs (luminance bottom voltage) and display voltages of other gradation levels are set lower than the optimum black display voltage Vs (a voltage range 1 shown in FIG. 3).

Incidentally, nowadays, liquid crystal display devices are also incorporated in cell phones and are required to be low in power consumption to elongate the duration of rechargeable batteries. Therefore, in ordinary, non-OCB liquid crystal display devices, in most of a non-display period, the pumping operation of a charge pump power supply voltage conversion circuit is suspended and the current supply ability of this power circuit is lowered (refer to Japanese Patent Application Kokai No. 2002-175049, for example).

However, OCB liquid crystal display devices are different from such ordinary liquid crystal display devices in that, first, it is necessary to cause a transition from spray alignment to bend alignment, that is, to cause an initial transition by applying a high voltage to the OCB liquid crystal, before establishing a display state.

Second, to maintain a displayable state, it is necessary to always apply, during display, a reverse transition prevention voltage for preventing a reverse transition from bend alignment to spray alignment. Once spray alignment is established because of a reverse transition, the above-mentioned initial transition needs to be made again to re-establish bend alignment.

Even in a standby state (no image is displayed), spray alignment is established in the liquid crystal unless the reverse transition prevention voltage is applied. Therefore, the initial transition needs to be made in displaying an image. This means a problem that because of the initial transition, more time is taken until an image appears on the liquid crystal display device. In particular, OCB liquid crystal display devices are prone to be influenced by temperature, and there is another problem that this transition takes longer time as the environment temperature lowers.

### BRIEF SUMMARY OF THE INVENTION

The present invention has been made in view of the above problems, and an object of the invention is therefore to provide a liquid crystal display device which can display an image quickly even when switching is made from a standby state to a display state and can maintain a standby state with a low power consumption.

The invention may provide a liquid crystal display device having an OCB liquid crystal panel, wherein in a standby state in which no image is displayed on the liquid crystal panel, an AC voltage which is applied to a liquid crystal is set higher than or equal to a reverse transition prevention voltage and a frame frequency is set lower than in an image display state.

According to the invention, since the AC voltage which is applied to the OCB liquid crystal is higher than or equal to the reverse transition prevention voltage, a display state can be established quickly from a standby state. Furthermore, since the frame frequency is lower than in the image display state, the power consumption can be kept low in the standby state.

### BRIEF DESCRIPTION OF THE DRAWINGS

FIG. 1 is a block diagram of a liquid crystal display device according to an embodiment of the present invention;

FIG. 2 is a timing chart of the liquid crystal display device of FIG. 1; and

FIG. 3 is a graph showing a relationship between the transmittance and the liquid crystal application voltage in an OCB liquid crystal display device.

### DETAILED DESCRIPTION OF THE INVENTION

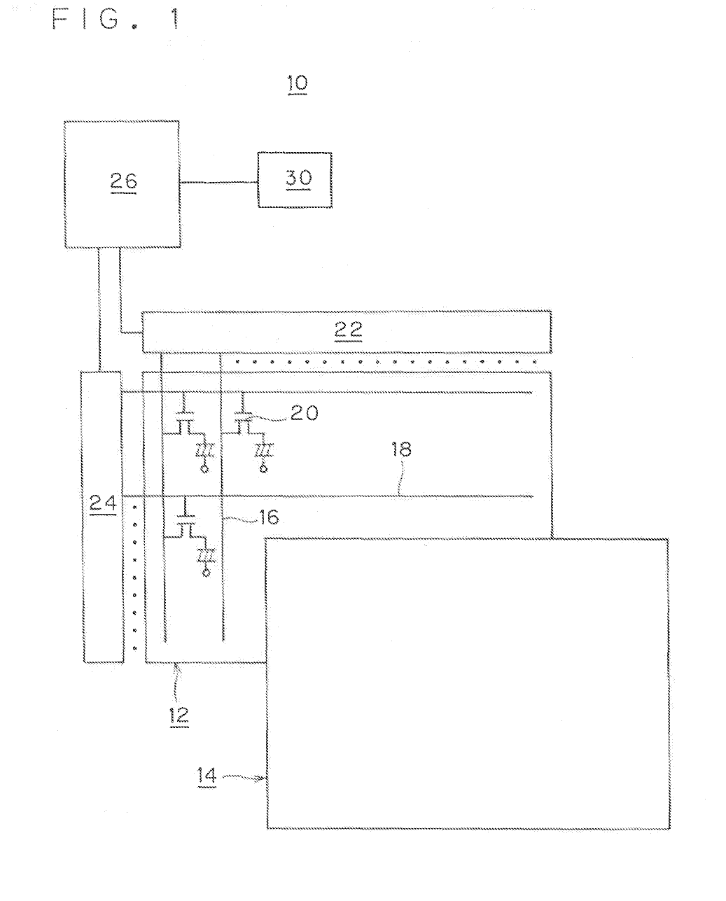

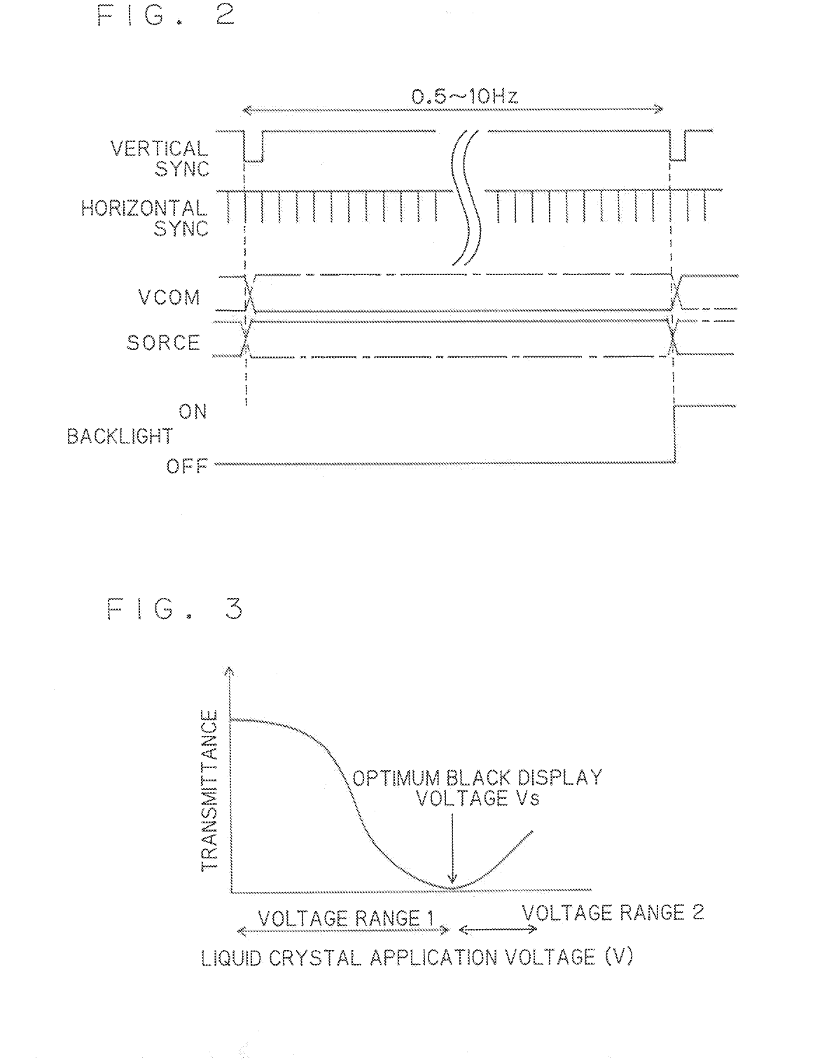

An OCB liquid crystal display device 10 according to an embodiment of the present invention will be hereinafter described with reference to FIGS. 1 and 2. For example, the liquid crystal display device 10 is a 3-inch WQVGA (240×RGB×400) liquid crystal display device used in a cell phone.

### (1) Configuration of Liquid Crystal Display Device 10

The configuration of the liquid crystal display device 10 will be described with reference to FIG. 1. The liquid crystal display device 10 is equipped with an array substrate 12, a counter substrate 14, and a liquid crystal (OCB liquid crystal) which is held between the substrates 12 and 14.

In the array substrate 12, plural signal lines 16 and plural scanning lines 18 are arranged perpendicularly to each other on a glass substrate and thin-film transistors (hereinafter abbreviated as TFTs) 20 are formed in matrix form in the vicinities of the respective crossing positions of the signal lines 16 and the scanning lines 18.

The signal lines 16 are supplied with liquid crystal drive voltages (video signals) from a signal line driver circuit 22 and the scanning lines 18 are supplied with gate signals from a scanning line driver circuit 24, whereby the TFTs 20 are driven.

The signal line driver circuit 22 and the scanning line driver circuit 24 are controlled by a controller 26. The liquid crystal display device 10 is also equipped with a backlight 30 whose tuning-on and turning-off are controlled by the controller 26.

### (2) Image Display State

To display an image on the liquid crystal display device 10, the backlight 30 is turned on and image signals are supplied from the signal line driver circuit 22. To prevent gradation inversion, an image is displayed while the voltages applied to the liquid crystal are controlled in the voltage range 1 shown in FIG. 3.

An image is displayed by frame inversion driving. That is, the polarities of a counter voltage Vcom which is applied to the counter electrode of the counter substrate 14 and source voltages which are supplied from the signal line driver 22 are inverted on a frame-by-frame basis.

### (3) Standby State

The image display state has been described above. Next, a standby state in which no image is displayed will be described with reference to a timing chart of FIG. 2.

The timing chart of FIG. 2 shows, in order from above, waveforms of a vertical sync signal, a horizontal sync signal, the counter voltage Vcom, and a source voltage.

The vertical sync signal is a clock signal which is output from the controller 26 to the scanning line driver circuit 26, and gate signals are output on the basis of this signal. The horizontal sync signal is output from the controller 26 to the signal line driver circuit 22, and video signals are output on the basis of the horizontal sync signal which serves as a clock signal. In the standby state, the backlight 30 is kept off.

Whereas the frame frequency of the vertical sync signal is 60 to 120 Hz in the image display state, it is lowered to 0.5 to 10 Hz (preferably 2.0 Hz) in the standby state (see FIG. 2). The counter voltage and the source voltages are applied so that the liquid crystal application voltages become the lowest voltage in a reverse transition prevention voltage range, (e.g., 1 V or more). It is preferable that the liquid crystal application voltages be higher than or equal to 1 V and lower than or equal to a black display voltage for expression of a black gradation level in image display (substantially equal to 6 V or somewhat lower). It is even preferable that the liquid crystal application voltages be higher than or equal to 2 V and lower than or equal to the black display voltage for expression of a black gradation level in image display (substantially equal to 6 V or somewhat lower). In this embodiment, 6 V is applied as an exemplary voltage. The relative polarity between the counter voltage Vcom and the source voltages are inverted in synchronism with the vertical sync signal.

The application of liquid crystal application voltages is controlled independently of the frame inversion driving at the time of image display, and may be done by one of the following three methods:

In the first method, the source voltages are constant and the counter voltage Vcom is inverted at the frame frequency.

In the second method, the counter voltage Vcom is constant and the source voltages are inverted at the frame frequency.

In the third method, both of the source voltages and the counter voltage Vcom are inverted at the frame frequency.

### (4) Advantages

Setting the frame frequency at 0.5 to 10 Hz which is lower than the one employed in the image display state (60 to 120 Hz) as described above makes it possible to keep the power consumption low.

On the other hand, since the reverse transition prevention voltage is always applied to the liquid crystal, an image can be displayed immediately even in the case of establishing a display state from a standby state. Where the liquid crystal display device 10 is a 3-inch WQVGA (240×RGB×400) liquid crystal display device and the temperature is −20° C., a display state can be established from a standby state in 1/30 sec, which is much shorter than in the case where the driving method of the embodiment is not employed (about 4 sec).

Since the power consumption can be kept low in the standby state and an image can be displayed immediately when a transition is made to a display state, the standby power consumption can be kept low and an image can be displayed immediately even in the case where the liquid crystal display device 10 is incorporated in a cell phone.

### (Modifications)

The invention is not limited to the above embodiment and various modifications are possible without departing from the spirit and scope of the invention.

In the above embodiment, the frame frequency is lowered in the standby state. In addition, upon a lapse of a prescribed time (e.g., 10 minutes) from the start of a standby state, the application of the reverse transition prevention voltage to the liquid crystal may be canceled (replaced by 0 V) to establish an off state. This makes it possible to keep the power consumption even lower.

Although the above embodiment is directed to the case of frame inversion driving, line inversion driving, column inversion driving, or dot inversion driving may be employed instead.

What is claimed is:

1. A liquid crystal display device having an OCB liquid crystal panel, wherein:
in a standby state in which no image is displayed on the liquid crystal panel, an AC voltage which is applied to a liquid crystal is set higher than or equal to a reverse transition prevention voltage and a frame frequency is set lower than in an image display state.

2. The liquid crystal display device according to claim 1, wherein in the standby state the frame frequency is 0.5 Hz to 1.0 Hz.

3. The liquid crystal display device according to claim 1, wherein in the standby state the AC voltage which is applied to the liquid crystal is set higher than or equal to 1 V.

4. The liquid crystal display device according to claim 1, wherein in the standby state the AC voltage which is applied to the liquid crystal is set higher than or equal to 1 V and lower than or equal to a block display voltage for expression of a black gradation level in image display.

5. The liquid crystal display device according to claim 1, wherein the liquid crystal panel performs display by frame inversion driving, line inversion driving, column inversion driving, or dot inversion driving.

6. The liquid crystal display device according to claim 1, wherein the AC voltage which is applied to the liquid crystal is changed to 0 V upon a lapse of a prescribed time from a start of a standby state of the liquid crystal panel.
